(19) United States
(12) Patent Application Publication
(10) Pub. No.: US 2020/0184296 A1
(43) Pub. Date: Jun. 11, 2020

(54) FINANCIAL CARD WITH STATUS INDICATORS

(71) Applicant: Capital One Services, LLC, McLean, VA (US)

(72) Inventor: Matthew Jordan Oliver, Whiteney, TX (US)

(73) Assignee: Capital One Services, LLC, McLean, VA (US)

(21) Appl. No.: 16/216,001

(22) Filed: Dec. 11, 2018

(51) Int. Cl. G06K 19/077; G06K 19/07

(52) U.S. Cl. CPC G06K 19/077; G06K 19/0723

(57) ABSTRACT

Embodiments of the present disclosure relate to financial cards and related systems and methods configured to provide status indicators to a user of the financial card. In some embodiments, the status indicators are provided as the financial card is engaged with an electronic terminal. In some embodiments, a financial card includes a light emitting diode module including one or more light emitting diodes, the light emitting diode module configured to indicate a status of the financial card, and a microprocessor chip configured to engage with an electronic terminal, determine the status of the financial card and modify the operation of the light emitting diode module in accordance with the determined status of the financial card.

### TECHNICAL FIELD

The present disclosure is directed towards an improved financial card having status indicators.

### BACKGROUND

Financial cards (e.g., credit cards, debit cards, and rewards cards) often include microprocessor chips and are commonly referred to as “smart cards” or “chip cards.” The microprocessor chips are used to communicate with an electronic terminal. The microprocessor chips may be used to generate a signature or generate a randomized one-time code for every transaction the financial card initiates after engaging with an electronic terminal. Common microprocessor chips include Europay-Mastercard-Visa (EMV) chips.

As microprocessor chips become more widely adopted, there has been a shift from swiping a financial card at an electronic terminal to read information stored on a magnetic strip located on the financial card, to having to “dip” or “insert” a financial card into an electronic terminal, where the data generated by the microprocessor chip is transmitted. However, because the time needed to process an inserted financial card is far greater than the time needed to swipe a magnetic strip of the financial card, users often withdraw their cards from the electronic terminals before the transaction is completed, leading to aborted transactions and related delays.

### SUMMARY

Embodiments of the present disclosure include a financial card and related systems and methods configured to provide status indicators to a user of the financial card. In some embodiments, the status indicators are provided as the financial card is engaged with an electronic terminal.

In some embodiments, a financial card includes a light emitting diode module including one or more light emitting diodes, the light emitting diode module configured to indicate a status of the financial card, and a microprocessor chip configured to engage with an electronic terminal, determine the status of the financial card and modify the operation of the light emitting diode module in accordance with the determined status of the financial card.

Further, in some embodiments, the status includes an active state where the microprocessor chip is at least one of receiving and transmitting data to the electronic terminal. In some embodiments, the status includes a dormant state where the microprocessor chip is not receiving or transmitting data to the electronic terminal. In some embodiments, the light emitting diode module includes a light emitting diode configured to turn on or off when the operation of the light emitting diode module is modified. In some embodiments, the light emitting diode module includes a plurality of light emitting diodes, wherein each of the plurality of light emitting diodes has at least one of a different position, color, and signal frequency. In some embodiments, modifying the operation of the light emitting diode module includes modifying the subset of the plurality of light emitting diodes emitting light. In some embodiments, the microprocessor chip is in compliance with an Europay-Mastercard-Visa (EMV) standard. In some embodiments, the financial card is at least one of a credit card, debit card, and rewards card. In some embodiments, the light emitting diode is positioned opposite of the microprocessor chip. In some embodiments, the financial card includes near field communication technology configured to allow a contactless transaction.

In some embodiments, a method includes the steps of determining the status of a financial card, and modifying the operation of a light emitting diode module responsive to determining the status of the financial card. The financial card may include a microprocessor chip configured to engage with an electronic terminal, and a light emitting diode module configured to indicate a status of the financial card.

In some embodiments, the status includes an active state where the microprocessor chip is at least one of receiving and transmitting data to the electronic terminal. In some embodiments, the status includes a dormant state where the microprocessor chip is not receiving or transmitting data to the electronic terminal. In some embodiments, the step of modifying the operation of the light emitting diode module includes turning on or off a light emitting diode of the light emitting diode module. In some embodiments, the light emitting diode module includes a plurality of light emitting diodes, where each of the plurality of light emitting diodes has at least one of a different position, color, and signal frequency. In some embodiments, the step of modifying the operation of the light emitting diode module comprises modifying a subset of the plurality of light emitting diodes emitting light. In some embodiments, the microprocessor chip includes an Europay-Mastercard-Visa (EMV) standard. In some embodiments, the financial card includes at least one of a credit card, debit card, and rewards card. In some embodiments, the light emitting diode is positioned opposite of the microprocessor chip. In some embodiments, the financial card includes near field communication technology configured to allow a contactless transaction.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1A illustrates a system including a financial card in accordance with some embodiments of the present disclosure.

FIG. 1B illustrates a system including a financial card in accordance with some embodiments of the present disclosure.

FIG. 1C illustrates a system including a financial card in accordance with some embodiments of the present disclosure.

FIG. 2 illustrates a financial card in accordance with some embodiments of the present disclosure.

FIG. 3 illustrates a financial card and electronic terminal in accordance with some embodiments of the present disclosure.

FIG. 4 illustrates a method including a financial card in accordance with some embodiments of the present disclosure.

### DETAILED DESCRIPTION

Embodiments of the present disclosure include a financial card and related systems and methods configured to provide status indicators to a user (e.g., customer, merchant) of the financial card.

In some embodiments, the status indicators may indicate when a transaction is in process and a card is actively engaged with an electronic terminal. Alternatively, status indicators may indicate a change in status (such as a financial card has finished a transaction, or a financial card is now actively transacting). Alternatively, status indicators may indicate why a transaction failed or was aborted. In some embodiments, the status indicators may be provided using light emitting diodes. In some embodiments, the status indicators may be provided by a speaker.

This may provide advantages to a user, who will have an indication of whether a financial card has completed its transaction, and the card can be removed from the electronic terminal. Often transaction processing can take in the range of 20-30 seconds, and in conventional systems impatient customers may withdraw their financial cards from the electronic terminal prior to the transaction being completed. Not only does this create problems for the customer, who is further delayed and may be unable to complete their transaction, and may have to restart the transaction, but it also negatively impacts the merchants, who may experience significantly longer check-out times and crowding at check-out areas.

Further, in some conventional systems, the electronic terminal provides the user with an indication that the transaction is complete by way of a sound (e.g., beep, chime), or by a written indication on a screen of the electronic terminal (e.g., “APPROVED”). However, there is no universal method of notifying the user, which may leave a user at a disadvantage. For example, when travelling abroad and encountering an electronic terminal configured in a language that the user is not fluent in, the user may be unaware if a transaction has been initiated, is being undertaken, or has been completed, if the electronic terminal is configured to provide written status updates. By contrast, the present system, provides a method of notifying the user of the status of the financial card that may be consistent, predictable, and uniform across all electronic terminals. Further, the financial card may be configured to be compatible with all conventional electronic terminals.

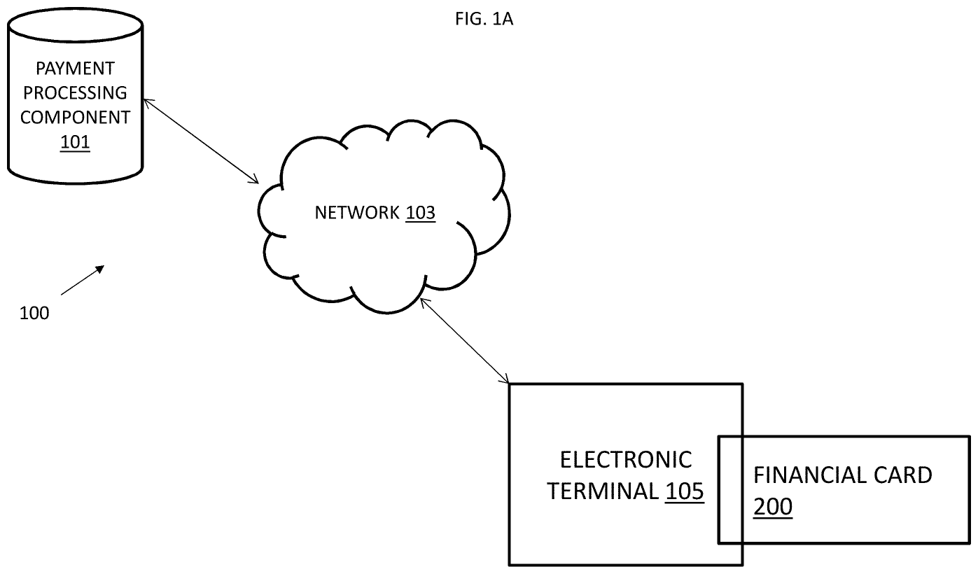

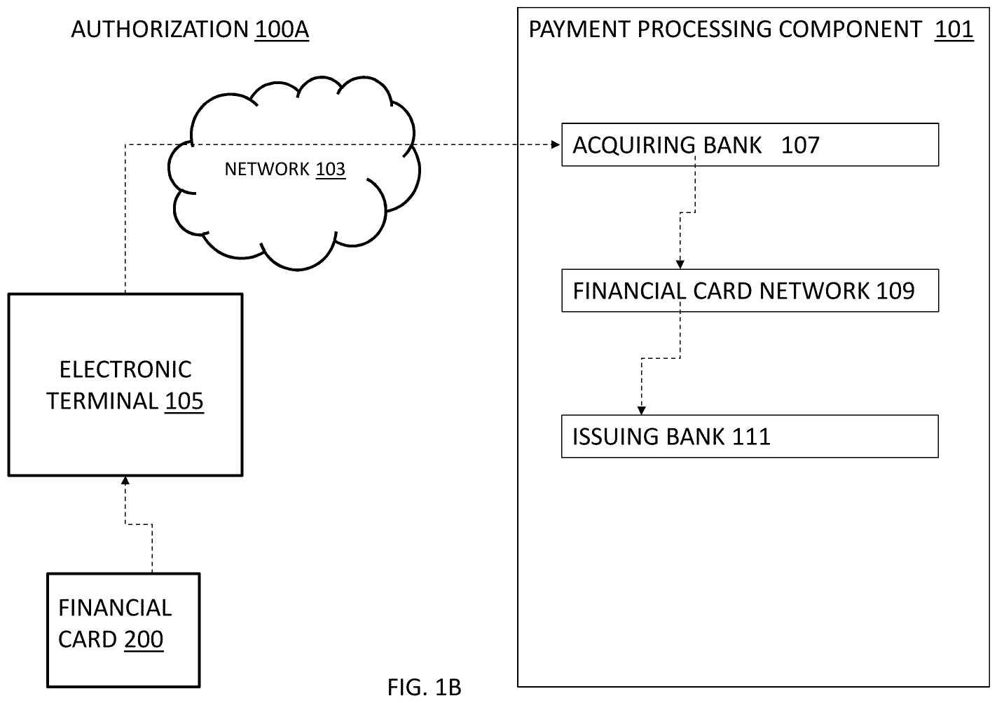

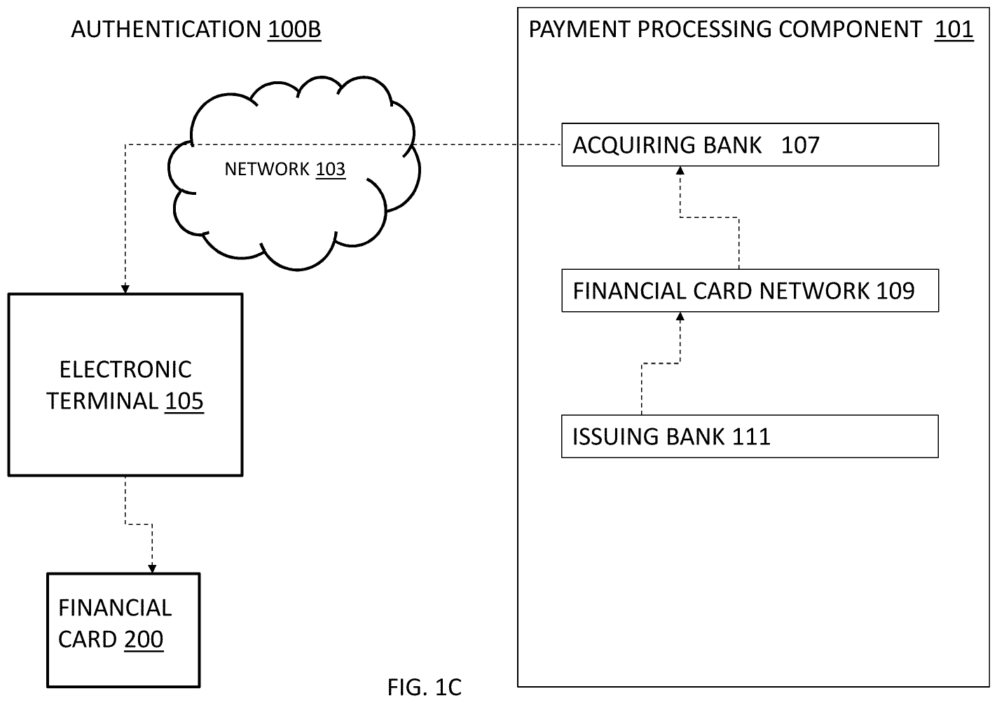

FIG. 1A illustrates a system 100 including a financial card 200 in accordance with some embodiments of the present disclosure. As illustrated in FIG. 1, the system 100 may include an electronic terminal 105 configured to engage with the financial card 200.

The electronic terminal 105 may be provided by a merchant. The electronic terminal may be communicatively coupled to a payment processing component 101 via a network 103. Electronic terminals 105 may also be referred to as payment terminals, point of sale terminals, credit card terminals, electronic fund transfer point of sale (EFTPOS) terminals and process data quickly (PDQ) terminals. Electronic terminal 105 may be configured to allow a user to insert, swipe, or manually enter financial card information. Alternatively, or additionally, the electronic terminal 105 may be configured to receive near field communication (NFC) contactless transactions. The electronic terminal 105 may be configured to transmit data received from a financial card 200 to a payment processing component 101 via the network 103 for authorization and/or transferring funds to a merchant involved in a transaction. The electronic terminal 105 may in turn receive data such as approvals, refusals, and provide the received data to the financial card 200. In some embodiments, the financial card 200 may be configured to interface with conventional electronic terminals 105 and/or conventional communication protocols for processing EMV and NFC transactions.

Network 103 may include a telephone line, internet connection, Bluetooth, Wi-Fi, cellular, satellite networks, and the like.

Example payment processing components 101 are illustrated in FIG. 1B and FIG. 1C and may include acquiring banks 107, financial card networks (e.g., VISA®, Mastercard®) 109, and issuing banks 111. Transactions using financial cards 200 may undergo a three stage process including (1) Authorization (see FIG. 1B), (2) Authentication (see FIG. 1C), and (3) Clearing and Settlement (not shown).

The authorization process 100A illustrated in FIG. 1B may take place after a user (customer and cardholder) initiates paying a merchant with a financial card 200 at an electronic terminal 105. In this case, the electronic terminal 105 transmits the data provided by the financial card 200 to an acquiring bank 107 that is affiliated with the merchant via the network 103. The acquiring bank 107 then forwards the financial card details to the financial card networks 109, which may then request payment authorization from an issuing bank 111 (affiliated with the customer or user of the financial card).

During the authentication process 100B illustrated in FIG. 1C, an issuing bank 111 processes the received payment authorization request from the financial card network 109. In particular, the issuing bank 111 may validate the received financial card number, check the amount of available funds, match the billing address to one on file, validate the card verification value (CVV) number and the like. The issuing bank 111 may approve or decline the transaction and then sends the approval/refusal to the merchant via the financial card network 109 and acquiring bank 107. The merchant may then notify the cardholder of the transaction being approved or declined.

During clearing and settlement (not shown) approved transactions may be posted to the financial card holder's billing statement as well as the merchant's statement.

Embodiments of the present disclosure may be configured to utilize approval or refusal information provided to the electronic terminal 105 and transmitted to the financial card 200 to provide updates to a user regarding the status of the financial card and/or transaction.

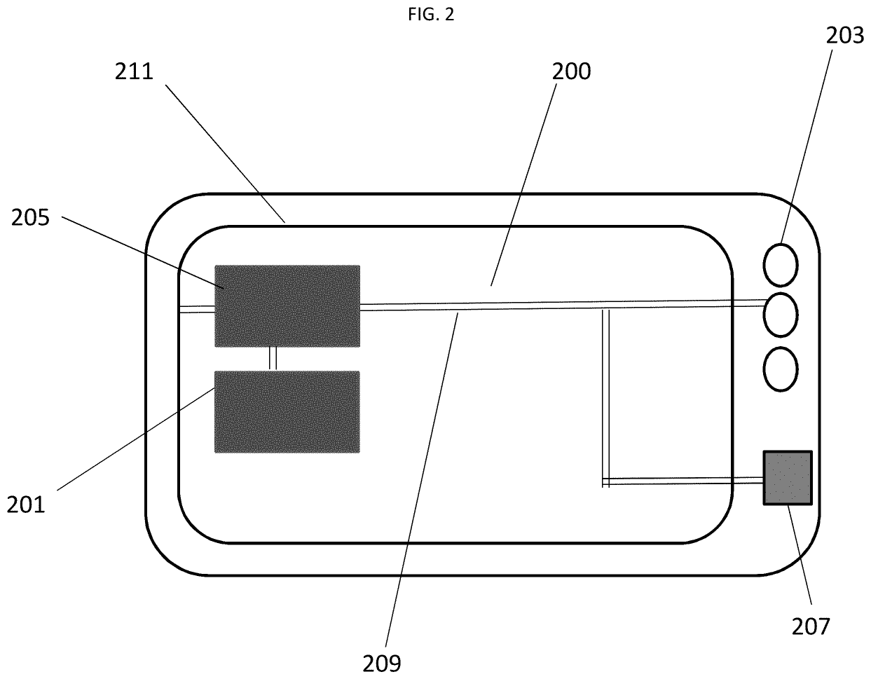

FIG. 2 illustrates a financial card in accordance with some embodiments of the present disclosure. As illustrated in FIG. 2, the financial card 200 may include a microprocessor chip 201 such as an Europay-Mastercard-Visa (EMV) chip or other appropriate integrated circuit. The microprocessor chip 201 may be configured to store data or information including information about a transaction instrument such as a user's account, including encryption keys, user specific information, authentication information, geolocation information, additional security mechanisms, and other appropriate data or information.

Financial cards 200 may include debit cards, credit cards, reward cards, and the like.

In some embodiments, the financial card 200 may be further configured to include a magnetic strip for backwards compatibility with conventional magnetic swipe systems. Further, in some embodiments, the financial card 200 may include near field communication (NFC) compatibility and may be configured to transmit and receive information from an electronic terminal 105 wirelessly. When the financial card 200 is inserted into an electronic terminal 105 (or in the case of NFC transmission, in the proximity of the electronic terminal 105), the financial card 200 may be powered by the electronic terminal 105. Further, the microprocessor chip 201 may be configured to transmit and receive data from the electronic terminal 105, when powered. Data may be transmitted and received between the financial card 200 and the electronic terminal 105 by way of an antenna 211. In some embodiments, the antenna 211 may be configured for use with electronic terminals configured for NFC transmissions.

As illustrated in FIG. 2, in some embodiments, the financial card 200 may include a light emitting diode module 203. The light emitting diode module 203 may include one or more light emitting diodes configured to emit light. The light emitting diode module 203 may be further configured to indicate a status of the financial card 200. When the microprocessor chip 201 engages with an electronic terminal 105 (i.e., inserting a financial card 200 into an electronic terminal 105, or wireless connection via NFC), the microprocessor chip 201 may determine the status of the financial card 200 (and the transaction) and modify the operation of the light emitting diode module 203 accordingly.

Optionally, in some embodiments, a second microprocessor chip 205 may be utilized to control the operation of a light emitting diode module 203. The second microprocessor chip 205 may receive one or more signals from the first microprocessor chip 201, determine a status of the financial card, and modulates the light emitting diode module 203 accordingly. In some embodiments, the second microprocessor chip 205 may include data and computer program code used to determine the status of the financial card and modulates the light emitting diode module 203. In such an embodiment, the first microprocessor chip 201 may be compatible for use with existing electronic terminals, and the second microprocessor chip 205 may be configured to provide power and control signals to the light emitting diode module 203.

Modifying the operation of the light emitting diode module 203 may include turning on or off the operation of one or more light emitting diodes contained within the module 203. The light emitting diode module 203 may be configured to change the number, positioning, color, or signal (e.g., frequency, pattern) emitting from the light emitting diodes based on the determined status of the financial card and/or transaction. In some embodiments, each of the light emitting diodes of the light emitting diode module 203 may have at least one of a different position, color, and signal frequency.

In some embodiments, the light emitting diode module 203 may include micro-LEDs. In some embodiments, the light emitting diodes may include tricolor diodes (e.g., Red-Green-Blue (RG) diodes), single color diodes, or white diodes. The light emitting diode module 203 may include one light emitting diode. Alternatively, the light emitting diode module 203 may include a plurality of light emitting diodes.

Example statuses may include dormant (e.g., financial card is physically engaged with (or in the proximity of) the electronic terminal but not transmitting or receiving data), active (e.g., financial card is physically engaged with the electronic terminal and transmitting or receiving data), and completed (e.g., financial card is physically engaged with the electronic terminal and the transaction has been completed or ended, the card is ready for removal from the electronic terminal).

In some embodiments, in addition to or in place of notifying a user that a transaction has been completed, the financial card 200 may provide a user with an indication of why a transaction was ended without the transaction being fulfilled. In some embodiments, the microprocessor chip 201 may be provided with a code from the electronic terminal 105 indicating whether a transaction has been approved, or declined. Standardized codes (e.g., approval code 00), or declined/refused (e.g., decline code 05) may be used. In conventional systems, electronic terminals 105 may be provided with a variety of decline codes indicating the reasons why a transaction was declined (i.e., invalid transaction, card amount invalid, card number invalid, no such issuer, insufficient funds, card expired, customer exceeds withdrawal limit, customer exceeds activity limit, etc.). In some embodiments, each decline code may be associated with a particular configuration of the light emitting diode modules.

In some embodiments, the light emitting diode module 203 may be positioned on the opposite end of the financial card 200 as the microprocessor chip 201. Accordingly, the light emitted by the light emitting diode module 203 may not be blocked or damaged by the electronic terminal 105. For example, the light emitting diode module 203 may be configured to fit within the ½ millimeter thickness of the financial card 200.

In some embodiments, the financial card 200 may include a speaker 207, such as a piezoelectric speaker. The speaker may be configured to emit a sound indicating the status of the financial card 200.

In some embodiment, electrical traces may be printed onto the plastic components of the financial card 200 to provide electrical and power connections from the microprocessor chip 201 to the light emitting diodes of the light emitting diode module 203.

Components of the financial card 200, including the light emitting diode module 203, the antenna 211, and/or the speaker 207 may be coupled via wiring/electrical traces 209.

In some embodiments, the microprocessor chip 201 may comprise a thin wafer disk formed from glass onto which micro circuits are embedded. The wafer disks may be sized using lasers and cutting techniques and then electronically wire bonded to gold contact pads, inserted into a credit card, and sealed.

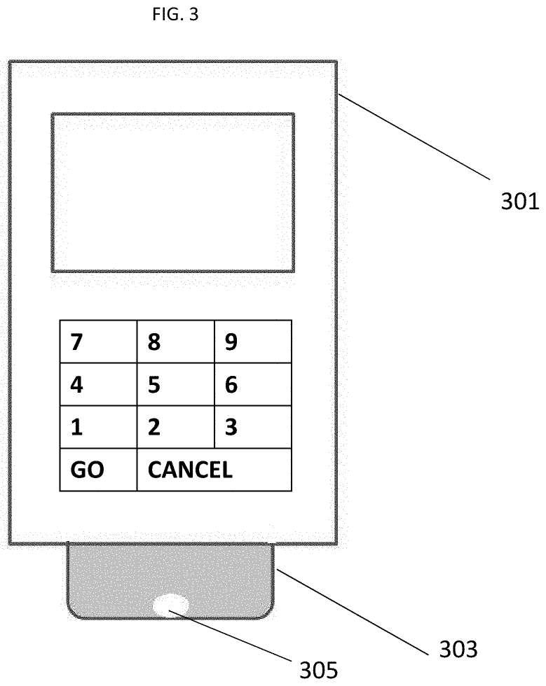

FIG. 3 illustrates a financial card 303 and electronic terminal 301 in accordance with some embodiments of the present disclosure. As illustrated in FIG. 3, the financial card 303 may include a light emitting diode 305 configured to emit a light corresponding to the status of the financial card (as discussed above).

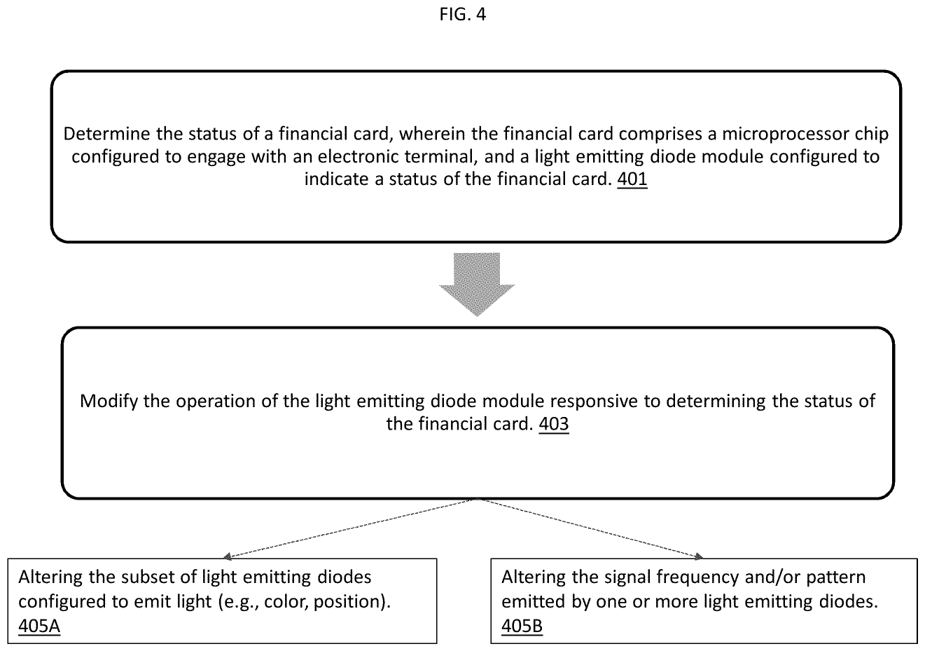

FIG. 4 illustrates a method including a financial card in accordance with some embodiments of the present disclosure. In a first step 401, the status of the financial card may be determined. In a second step 403, the operation of the light emitting diode module may be modified responsive to determining the status of the financial card. For example, step 403 may include altering the subset of light emitting diodes configured to emit light 405A, or altering the signal frequency and/or pattern being emitted by one or more of the light emitting diodes 40B. The light emitting diodes may differ in their color, position, and the like.

Although the present disclosure may provide a sequence of steps, it is understood that in some embodiments, additional steps may be added, described steps may be omitted, and the like. Additionally, the described sequence of steps may be performed in any suitable order.

While illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified.

Thus, the foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments.

1. A financial card comprising:
a light emitting diode module comprising one or more light emitting diodes and configured to indicate a change in status of the financial card from an active state to a dormant state or from a dormant state to an active state; and
a microprocessor chip configured to engage with an electronic terminal, determine the status of the financial card and modify the operation of the light emitting diode module in accordance with the determined status of the financial card, wherein the microprocessor chip is at least one of receiving or transmitting data to the electronic terminal in the active state and the microprocessor chip is not receiving or transmitting data to the electronic terminal in the dormant state,
wherein, the financial card comprises a credit card, debit card, stored-value card, or rewards card and is configured to be inserted into the electronic terminal to facilitate a payment transaction.

2. (canceled)

3. (canceled)

4. The financial card of claim 1, wherein the light emitting diode module includes a light emitting diode configured to turn on or off when the operation of the light emitting diode module is modified.

5. The financial card of claim 1, wherein the light emitting diode module comprises a plurality of light emitting diodes, wherein each of the plurality of light emitting diodes has at least one of a different position, color, and signal frequency.

6. The financial card of claim 5, wherein modifying the operation of the light emitting diode module comprises modifying the subset of the plurality of light emitting diodes emitting light.

7. The financial card of claim 1, wherein the microprocessor chip comprises an Europay-Mastercard-Visa (EMV) standard.

8. (canceled)

9. The financial card of claim 1, wherein the light emitting diode is positioned opposite of the microprocessor chip.

10. The financial card of claim 1, comprising near field communication technology configured to allow a contactless transaction.

11. A method comprising:
determining the status of a financial card, wherein the financial card comprises a microprocessor chip configured to engage with an electronic terminal, and a light emitting diode module configured to indicate a status of the financial card, and wherein the financial card comprises a credit card, debit card, or rewards card and is configured to be inserted into the electronic terminal to facilitate a payment transaction; and
modifying the operation of the light emitting diode module responsive to determining a change in status of the financial card, the change in status comprising a change from an active state to a dormant state or a change from a dormant state to an active state, wherein the microprocessor chip is at least one of receiving or transmitting data to the electronic terminal in the active state and the microprocessor chip is not receiving or transmitting data to the electronic terminal in the dormant state.

12. (canceled)

13. (canceled)

14. The method of claim 11, wherein modifying the operation of the light emitting diode module comprises turning on or off a light emitting diode of the light emitting diode module.

15. The method of claim 11, wherein the light emitting diode module comprises a plurality of light emitting diodes, wherein each of the plurality of light emitting diodes has at least one of a different position, color, and signal frequency.

16. The method of claim 15, wherein modifying the operation of the light emitting diode module comprises modifying a subset of the plurality of light emitting diodes emitting light.

17. The method of claim 15, wherein the microprocessor chip comprises an Europay-Mastercard-Visa (EMV) standard.

18. (canceled)

19. The method of claim 15, wherein the light emitting diode is positioned opposite of the microprocessor chip.

20. The method of claim 15, wherein the financial card comprises near field communication technology configured to allow a contactless transaction.
